(19) United States
(12) Patent Application Publication
(10) Pub. No.: US 2025/0385558 A1
(43) Pub. Date: Dec. 18, 2025

(54) ROTOR SLEEVE AND ROTOR

(71) Applicant: FANUC CORPORATION, Yamanashi (JP)

(72) Inventors: Katsuhiro SAIGUSA, Yamanashi (JP); Kenji KAWAI, Yamanashi (JP)

(21) Appl. No.: 18/877,383

(22) PCT Filed: Jul. 19, 2022
(86) PCT No.: PCT/JP2022/027988

§ 371 Date: Dec. 20, 2024

(51) Int. Cl. H02K 1/30

(52) U.S. Cl. CPC H02K 1/30

(57) ABSTRACT

The rotor sleeve includes a through-hole into which a shaft including a small-diameter shaft portion and a large-diameter shaft portion, having different outer diameters and disposed side by side in a direction of an axis are fitted. The through-hole includes a small-diameter hole portion and a large-diameter hole portion that are disposed away from each other in the direction of the axis and into which the small-diameter shaft portion and the large-diameter shaft portion are tightly fitted, respectively. An intermediate hole portion is disposed between the small-diameter hole portion and the large-diameter hole portion. Each of the small-diameter hole portion and the large-diameter hole portion includes, in an inner surface thereof, a groove extending from an intermediate position thereof in the direction of the axis to the intermediate hole portion. The rotor sleeve includes an oil-pressure supply hole that is formed in an inner surface of the intermediate hole portion or an inner surface of the groove.

### CROSS-REFERENCE TO RELATED APPLICATION(S)

This is a National Stage Entry into the United States Patent and Trademark Office from International Patent Application No. PCT/JP2022/027988, filed on Jul. 19, 2022, the entire contents of which are incorporated herein by reference.

### FIELD OF THE INVENTION

The present disclosure relates to a rotor sleeve and a rotor.

### BACKGROUND OF THE INVENTION

A rotor including a shaft having a step portion and a sleeve to be fitted to the shaft is known (for example, see Japanese Unexamined Patent Application, Publication No. S62-98444). The sleeve has a cavity disposed so as to cover the step portion and has an oil-pressure supply hole communicating with the cavity.

In assembling the rotor, the sleeve is shrink-fitted to the shaft. By doing so, the sleeve and the shaft are fixed to each other with a high contact pressure on both sides of the cavity in the direction of the axis. In disassembling the rotor, an oil pressure is supplied to the interior of the cavity through the oil-pressure supply hole to expand the sleeve in the radial direction by elastic deformation, and the sleeve is removed from the shaft by the force in the direction of the axis applied to the step portion of the shaft.

### SUMMARY OF INVENTION

An aspect of the present disclosure is a rotor sleeve including a through-hole into which a shaft including a small-diameter shaft portion and a large-diameter shaft portion having different outer diameters and disposed side by side in a direction of an axis is fitted. The through-hole includes: a small-diameter hole portion and a large-diameter hole portion that are disposed away from each other in the direction of the axis and into which the small-diameter shaft portion and the large-diameter shaft portion are tightly fitted, respectively; and an intermediate hole portion disposed between the small-diameter hole portion and the large-diameter hole portion. Each of the small-diameter hole portion and the large-diameter hole portion includes, in an inner surface thereof, a groove extending from an intermediate position thereof in the direction of the axis to the intermediate hole portion. The rotor sleeve includes an oil-pressure supply hole that is formed in an inner surface of the intermediate hole portion or an inner surface of the groove.

### BRIEF DESCRIPTION OF THE DRAWINGS

FIG. 1 is a vertical sectional view of a rotor according to a first embodiment of the present disclosure.

FIG. 2 is a vertical sectional view of a sleeve according to the first embodiment of the present disclosure, which constitutes the rotor in FIG. 1.

FIG. 3 is a vertical sectional view for explaining the operation of the rotor in FIG. 1 and the sleeve in FIG. 2.

FIG. 4 is a front view of a main shaft constituting the rotor in FIG. 1.

FIG. 5 is a vertical sectional view showing a first modification of the sleeve in FIG. 2.

FIG. 6 is a vertical sectional view showing a second modification of the sleeve in FIG. 2.

FIG. 7 is a vertical sectional view showing a third modification of the sleeve in FIG. 2.

FIG. 8 is a vertical sectional view of a rotor according to a second embodiment of the present disclosure.

FIG. 9 is a vertical sectional view showing a modification of the rotor in FIG. 8.

### DESCRIPTION OF EMBODIMENT(S) OF THE INVENTION

Hereinbelow, a sleeve 4 and a rotor 1 according to a first embodiment of the present disclosure will be described with reference to the drawings.

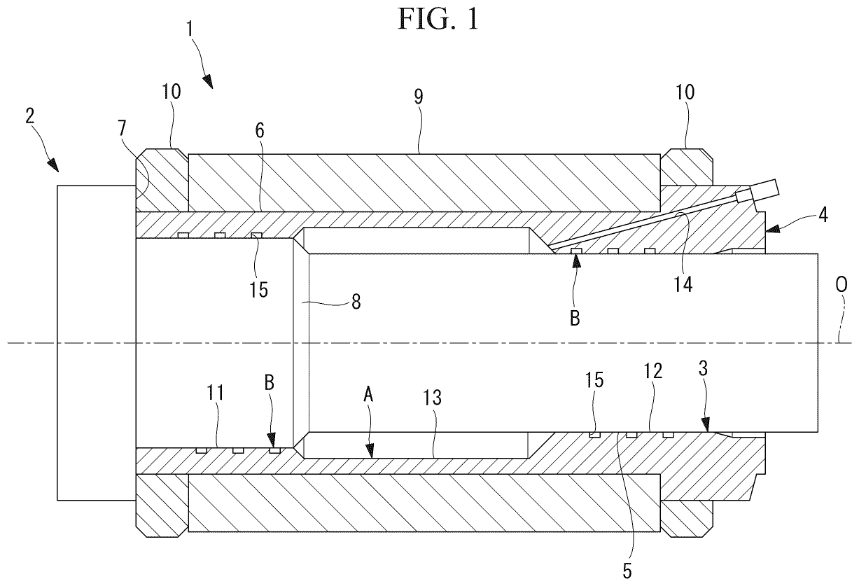

The rotor 1 according to this embodiment is, for example, a rotor for a built-in motor in which a stator is incorporated in an industrial machine. As shown in FIG. 1, the rotor 1 includes a main shaft (shaft) 2 and a cylindrical sleeve (rotor sleeve) 4 having a through-hole 3 into which the main shaft 2 is fitted.

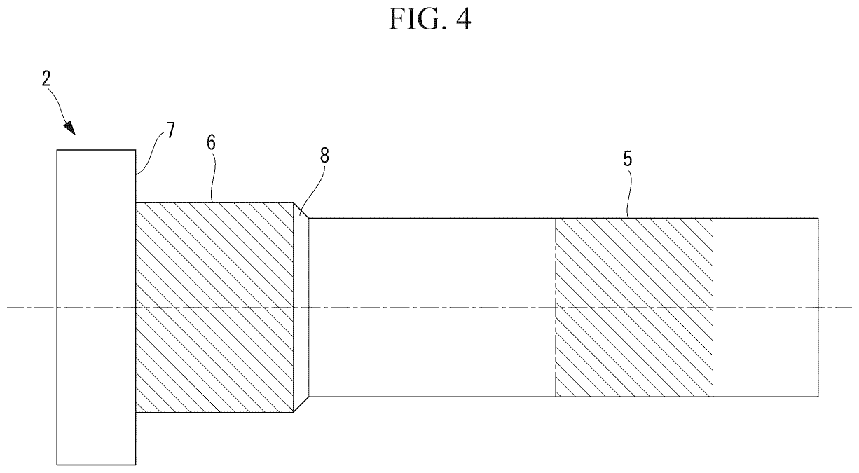

As shown in FIGS. 1 and 4, the main shaft 2 includes a small-diameter shaft portion 5 and a large-diameter shaft portion 6 disposed side by side in a direction of an axis O. The main shaft 2 includes an abutting surface 7 against which an end surface of the sleeve 4 on the large-diameter shaft portion 6 side in the direction of an axis abuts.

The small-diameter shaft portion 5 and the large-diameter shaft portion 6 are each a smooth cylindrical face, and the large-diameter shaft portion 6 has a larger outer diameter than the small-diameter shaft portion 5. A step 8 having a height corresponding to the difference in outer diameter (radius) between the small-diameter shaft portion 5 and the large-diameter shaft portion 6 is formed between the small-diameter shaft portion 5 and the large-diameter shaft portion 6.

An iron core 9 is shrink-fitted to the outer surface of the sleeve 4. Side rings 10 are fixed to both ends of the iron core 9 in the direction of the axis O. The side rings 10 have a larger outer diameter than the iron core 9 to protect the inner surface of the stator such that the iron core 9 does not contact the inner surface of the stator when the rotor 1 is inserted into the stator. The side rings 10 have a plurality of screw holes (not shown) for fixing weights for adjusting the balance of the rotor 1.

The side rings 10 are made of a non-magnetic material to block a magnetic path from the iron core 9. Because the coefficient of linear expansion of a non-magnetic material is typically larger than that of a magnetic material constituting the iron core 9, the side rings 10 are fixed, by shrink fitting, to the outer surface of the sleeve 4 with an interference larger than that of the iron core 9.

The through-hole 3 in the sleeve 4 has a large-diameter hole portion 11 at one end thereof in the direction of the axis O, into which the large-diameter shaft portion 6 of the main shaft 2 is to be tightly fitted. The through-hole 3 in the sleeve 4 also has a small-diameter hole portion 12 at the other end thereof in the direction of the axis O, into which the small-diameter shaft portion 5 of the main shaft 2 is to be tightly fitted. In this embodiment, the small-diameter hole portion 12 and the large-diameter hole portion 11 have substantially the same length in the direction of the axis O.

The through-hole 3 in the sleeve 4 also has an intermediate hole portion 13 at a position between the small-diameter hole portion 12 and the large-diameter hole portion 11 in the direction of the axis O. In this embodiment, the intermediate hole portion 13 has a larger length in the direction of the axis O than the small-diameter hole portion 12 and the large-diameter hole portion 11 and a larger inner diameter than the large-diameter hole portion 11. An oil-pressure supply hole 14 for supplying an oil pressure from the outside is formed in the inner surface of the intermediate hole portion 13.

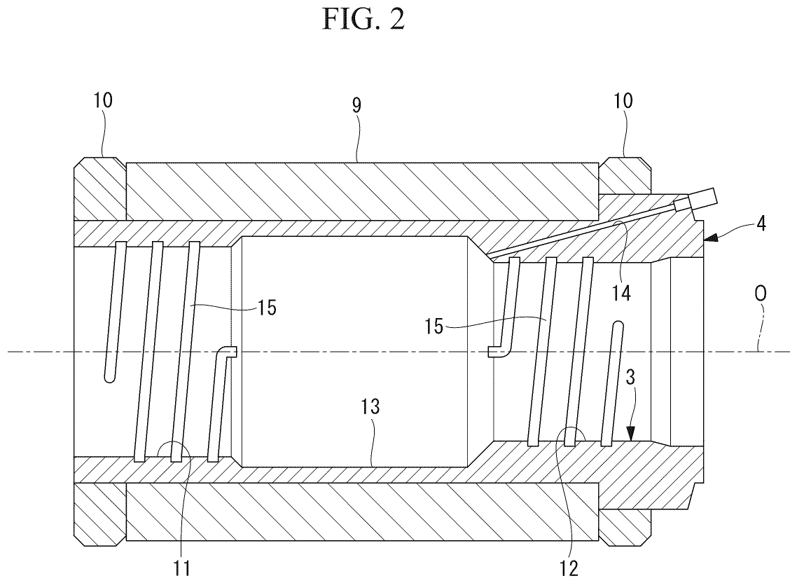

In this embodiment, as shown in FIG. 2, a spiral groove (groove) 15 is formed in the inner surface of each of the small-diameter hole portion 12 and the large-diameter hole portion 11 of the sleeve 4. The spiral groove 15 is formed from an intermediate position of each of the small-diameter hole portion 12 and the large-diameter hole portion 11 in the direction of the axis O to a boundary position with the intermediate hole portion 13 and joins the intermediate hole portion 13.

In the example shown in FIG. 2, the spiral grooves 15 have a predetermined groove width, a predetermined pitch, and multiple turns along the direction of the axis O. The direction of turns of the spiral grooves 15 may be arbitrary.

The width, pitch, and number of turns of the spiral grooves 15 are appropriately set based on the magnitude of the radial force obtained by the supplied oil pressure. The radial force obtained by the oil pressure can be increased by increasing the width, decreasing the pitch, and increasing the number of turns of the spiral grooves 15. This in turn reduces the contact area between the small-diameter hole portion 12 and the small-diameter shaft portion 5 and the contact area between the large-diameter hole portion 11 and the large-diameter shaft portion 6, lowering the frictional force therebetween.

Hence, the width, pitch, and number of turns of the spiral grooves 15 are set to appropriate values on the basis of the relationship between the frictional force and the magnitude of the radial force obtained by the oil pressure.

The operation of the thus-configured sleeve 4 and rotor 1 according to this embodiment will be described below. In order to assemble the rotor 1 according to this embodiment, the iron core and the side rings 10 are shrink-fitted to the outer surface of the sleeve 4 in advance.

Then, the main shaft 2 is inserted into the through-hole 3 in the sleeve 4 by shrink fitting from the left side to the right side in FIG. 1 with respect to the assembly of the sleeve 4, the iron core 9, and the side rings 10. The main shaft 2 and the sleeve 4 can be positioned with respect to each other in the direction of the axis O by abutting the abutting surface 7 of the main shaft 2 against the end surface of the sleeve 4 on the large-diameter hole portion 11 side.

In this state, the small-diameter shaft portion 5 of the main shaft 2 is tightly fitted into the small-diameter hole portion 12 of the sleeve 4, and the large-diameter shaft portion 6 of the main shaft 2 is tightly fitted into the large-diameter hole portion 11 of the sleeve 4. Thus, the main shaft 2 and the sleeve 4 are fixed to each other. As a result, a sealed space is defined between the main shaft 2 and the sleeve 4.

At the position of the intermediate hole portion 13, a cylindrical first space A is defined between the intermediate hole portion 13 and the outer surface of the main shaft 2 facing the intermediate hole portion 13 in the radial direction. At the positions of the small-diameter hole portion 12 and the large-diameter hole portion 11, spiral second spaces B each having one end as a dead end are defined between the spiral grooves 15 and the outer surface of the main shaft 2 facing the spiral grooves 15. Each of the spiral second spaces B opens in the first space A at the other end thereof.

In order to disassemble the rotor 1, a high oil pressure is supplied to the first space A through the oil-pressure supply hole 14. The oil pressure supplied to the first space A is also supplied to the spiral second spaces B that are continuous with the first space A.

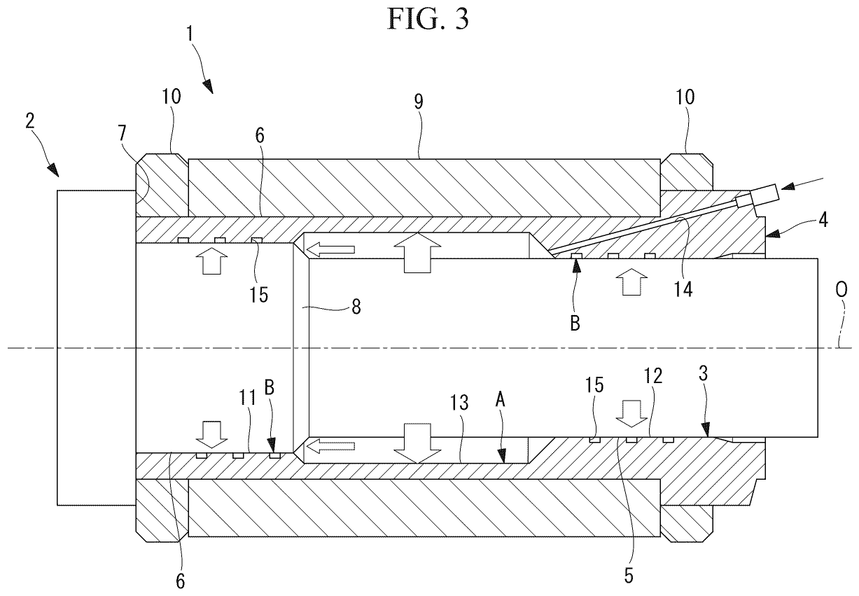

In the first space A, as indicated by arrows in FIG. 3, a force for expanding the sleeve 4 in the radial direction acts due to the oil pressure. As indicated by arrows, an axial force proportional to the difference in cross-sectional area between the large-diameter shaft portion 6 and the small-diameter shaft portion 5 acts on the step 8 provided in the main shaft 2.

Furthermore, in this embodiment, as a result of the oil pressure being supplied from the first space A to the spiral second spaces B, the sleeve 4 is expanded in the radial direction also at the small-diameter hole portion 12 and the large-diameter hole portion 11, as indicated by arrows.

As a result, the contact pressure between the small-diameter shaft portion 5 and the small-diameter hole portion 12 and the contact pressure between the large-diameter shaft portion 6 and the large-diameter hole portion 11 decrease, allowing the main shaft 2 to be easily removed from the sleeve 4 with the axial force generated by the oil pressure.

In this case, because the intermediate hole portion 13 is longer than the small-diameter hole portion 12 and the large-diameter hole portion 11 in the direction of the axis O, even a low oil pressure can generate a large force for expanding the sleeve 4 in the radial direction at the central portion of the sleeve 4 in the direction of the axis O.

Meanwhile, the side rings 10 are fitted to both ends of the sleeve 4 in the direction of the axis O with a large interference. Hence, expansion thereof in the radial direction due to the oil pressure is suppressed compared with that of the central portion in the direction of the axis O. Hence, particularly when the sleeve 4 has been reduced in thickness and weight, the sleeve 4 tends to be elastically deformed into a so-called barrel shape, which is large at the center and small at both ends in the direction of the axis O, when an oil pressure is supplied.

According to this embodiment, by providing the spiral grooves 15 in the inner surfaces of the small-diameter hole portion 12 and the large-diameter hole portion 11, it is possible to generate a force for expanding the sleeve 4 in the radial direction also at both ends in the direction of the axis O. Thus, the contact pressure between the small-diameter hole portion 12 and the small-diameter shaft portion 5 and between the large-diameter hole portion 11 and the large-diameter shaft portion 6 can be easily reduced.

In other words, there is an advantage in that, even when the sleeve 4 has been reduced in thickness and weight, it is possible to ease the elastic deformation into a barrel shape due to the supply of oil pressure and to easily remove the main shaft 2 from the sleeve 4.

As a result, with the sleeve 4 and the rotor 1 according to this embodiment, the thickness and weight of the sleeve 4 can be reduced, thus enabling reduction in weight and cost of the rotor 1 and the motor and increase in diameter and rigidity of the main shaft 2.

Furthermore, with the sleeve 4 and the rotor 1 according to this embodiment, because the spiral grooves 15 are formed in the inner surfaces of the small-diameter hole portion 12 and the large-diameter hole portion 11, there is no need to machine grooves in the outer surface of the main shaft 2. In a built-in motor, a user prepares the main shaft 2. Hence, eliminating the need for machining grooves in the outer surface of the main shaft 2 saves the user trouble of performing special machining, which is advantageous.

Furthermore, according to this embodiment, the inner diameter of the intermediate hole portion 13 is set to be larger than that of the large-diameter hole portion 11. Thus, it is only necessary to prepare a main shaft 2 with a simple shape that has two cylindrical faces with different diameters, namely, a smooth small-diameter shaft portion 5 and a smooth large-diameter shaft portion 6. This also eliminates the need for the user to perform special machining on the main shaft 2.

Furthermore, by making the inner diameter of the intermediate hole portion 13 larger than the inner diameter of the small-diameter hole portion 12, the small-diameter shaft portion 5 can be fitted into the small-diameter hole portion 12 without contacting the inner surface of the intermediate hole portion 13 when the main shaft 2 is inserted into the through-hole 3 in the sleeve 4. Thus, the task of inserting the main shaft 2 into the sleeve 4 is easy.

In the sleeve 4 and the rotor 1 according to this embodiment, the intermediate hole portion 13 is formed to have a larger length in the direction of the axis O than the small-diameter hole portion 12 and the large-diameter hole portion 11. There is a gap between the intermediate hole portion 13 and the outer surface of the main shaft 2 in the radial direction, and the main shaft 2 and the sleeve 4 do not fit together. Hence, the requirements for the surface roughness and the surface accuracy are low.

Only the small-diameter hole portion 12 and the large-diameter hole portion 11 located at the ends of the sleeve 4 in the direction of the axis O and the small-diameter shaft portion 5 and the large-diameter shaft portion 6 to be fitted thereto require precise machining. Hence, in the sleeve 4, the area to be precisely machined is not the entire length of the sleeve 4, but a limited part of the sleeve 4 in the direction of the axis O. This is advantageous in that the machining cost can be reduced.

Furthermore, also in the main shaft 2, there is no need to perform precise machining on the entire area of the small-diameter shaft portion 5 and the large-diameter shaft portion 6. As shown by hatching in FIG. 4, precise machining is required only at the area to be fitted into the small-diameter hole portion 12 and the large-diameter hole portion 11. This also saves the user trouble.

In this embodiment, the spiral grooves 15 formed in the small-diameter hole portion 12 and the large-diameter hole portion 11 turn around the axis O a plurality of times at a predetermined pitch. The spiral grooves 15 are grooves distributed in the circumferential direction in the small-diameter hole portion 12 and the large-diameter hole portion 11.

This makes it possible to distribute the radial force generated by the oil pressure substantially uniformly in the direction of the axis O and the circumferential direction of the small-diameter hole portion 12 and the large-diameter hole portion 11. Hence, the small-diameter hole portion 12 and the large-diameter hole portion 11 can be uniformly expanded in the circumferential direction to uniformly reduce the contact pressure.

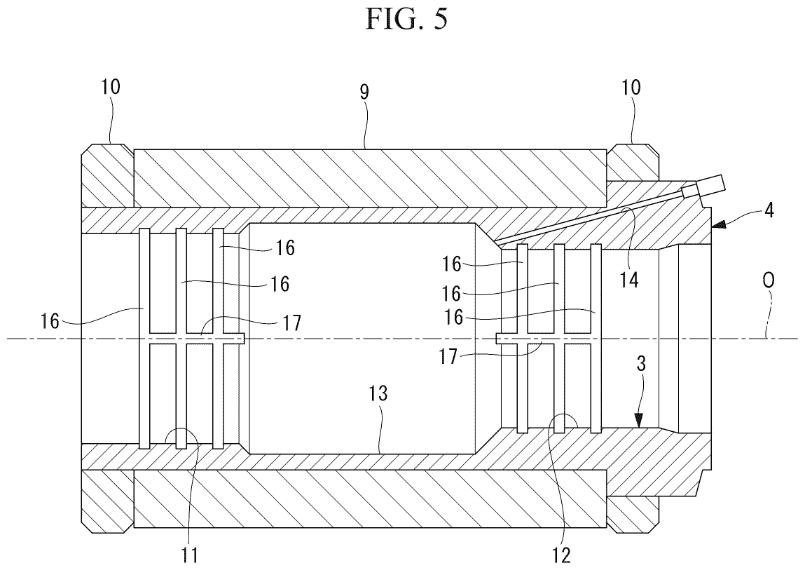

In the sleeve 4 and the rotor 1 according to this embodiment, the spiral grooves 15 are provided in the small-diameter hole portion 12 and the large-diameter hole portion 11. Instead of this, as shown in FIG. 5, a plurality of circumferential grooves 16 extending annularly in the circumferential direction may be provided at intervals in the direction of the axis O, and linear connecting grooves 17 extending in the direction of the axis O may be provided at any position in the circumferential direction. The connecting grooves 17 connect the plurality of circumferential grooves 16 to the intermediate hole portion 13.

Also with this structure, the circumferential grooves 16 are distributed in the direction of the axis O and the circumferential direction, allowing the oil pressure supplied to the first space A to be supplied to the circumferential grooves 16 through the connecting grooves 17. The annular circumferential grooves 16 and the linear connecting grooves 17 can be machined more easily than the spiral grooves 15.

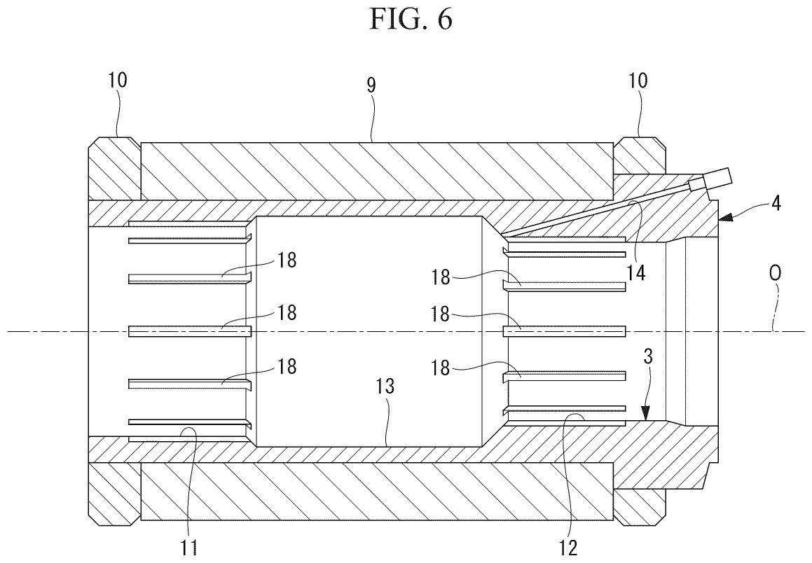

Furthermore, as shown in FIG. 6, a plurality of linear grooves (grooves) 18 extending linearly in the direction of the axis O may be disposed at intervals in the circumferential direction. The linear grooves 18 extend from an intermediate position of each of the small-diameter hole portion 12 and the large-diameter hole portion 11 in the direction of the axis O to the boundary with the intermediate hole portion 13 and join the intermediate hole portion 13.

Also with this structure, the linear grooves 18 are distributed in the circumferential direction, allowing the oil pressure supplied to the first space A to be supplied to the linear grooves 18. The linear grooves 18 can be machined more easily than the spiral grooves 15.

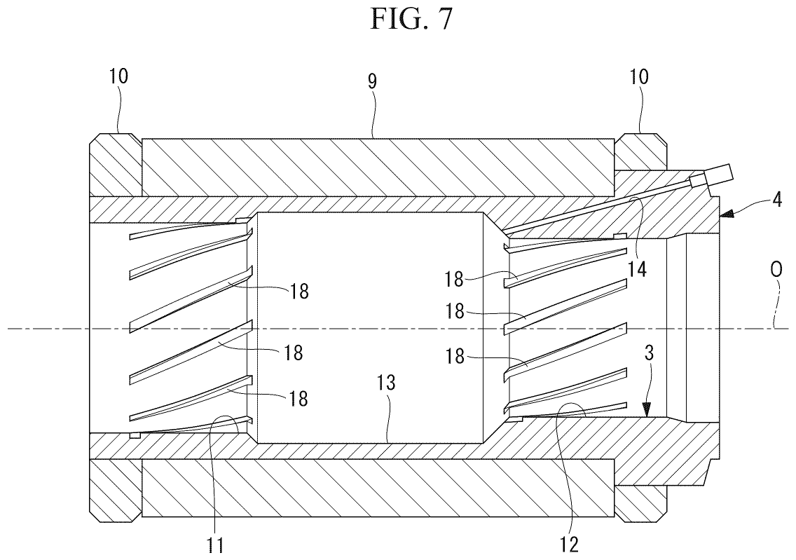

Furthermore, the plurality of linear grooves 18 formed at intervals in the circumferential direction may be twisted around the axis O, as shown in FIG. 7.

In this embodiment, the intermediate hole portion 13 is formed to have a larger inner diameter than the large-diameter hole portion 11. However, the inner diameter of the intermediate hole portion 13 may be the same as that of the large-diameter hole portion 11, or may be larger than that of the small-diameter hole portion 12 and smaller than or equal to that of the large-diameter hole portion 11. If the inner diameter of the intermediate hole portion 13 is larger than that of the small-diameter hole portion 12, an axial force can be generated by the oil pressure. This makes insertion of the main shaft 2 into the sleeve 4 easy.

In this embodiment, the dimension of the intermediate hole portion 13 in the direction of the axis O is set to be larger than the dimensions of the small-diameter hole portion 12 and the large-diameter hole portion 11 in the direction of the axis O. Instead of this, the dimension of the intermediate hole portion 13 in the direction of the axis O may be smaller than or equal to the dimensions of the small-diameter hole portion 12 and the large-diameter hole portion 11 in the direction of the axis O.

Next, a rotor 20 according to a second embodiment of the present disclosure will be described below with reference to the drawings.

In the description of this embodiment, the same reference numerals denote the same components as those of the rotor 1 according to the first embodiment described above, and the description thereof will be omitted.

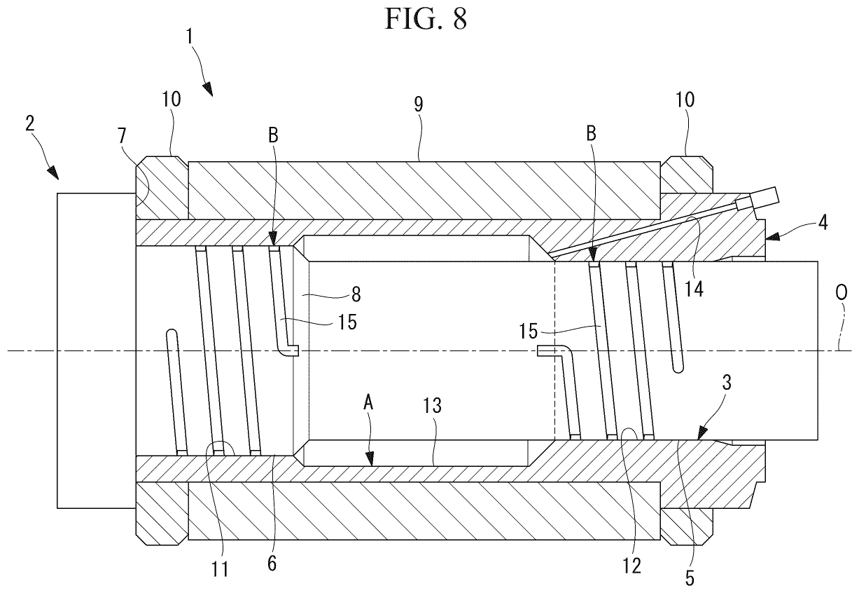

As shown in FIG. 8, the rotor 20 according to this embodiment differs from the rotor 1 according to the first embodiment in that the spiral grooves 15 are not provided in the sleeve 4, but are formed in the small-diameter shaft portion 5 and the large-diameter shaft portion 6 of the main shaft 2.

One spiral groove 15 extends from an intermediate position in the direction of the axis O of the small-diameter shaft portion 5 facing the small-diameter hole portion 12 to a position beyond the boundary between the small-diameter hole portion 12 and the intermediate hole portion 13. The other spiral groove 15 extends from an intermediate position in the direction of the axis O of the large-diameter shaft portion 6 facing the large-diameter hole portion 11 to the boundary between the large-diameter hole portion 11 and the intermediate hole portion 13.

Also with this structure, when an oil pressure is supplied to the first space A, the oil pressure is also supplied to the second spaces B in a spiral shape from the first space A. Hence, a force for expanding the sleeve 4 in the radial direction can be generated not only in the intermediate hole portion 13, but also in the small-diameter hole portion 12 and the large-diameter hole portion 11.

Furthermore, instead of the spiral grooves 15, circumferential grooves 16 and connecting grooves 17 similar to those in FIG. 5 or linear grooves 18 similar to those in FIG. 6 may be formed in the small-diameter shaft portion 5 and the large-diameter shaft portion 6 of the main shaft 2.

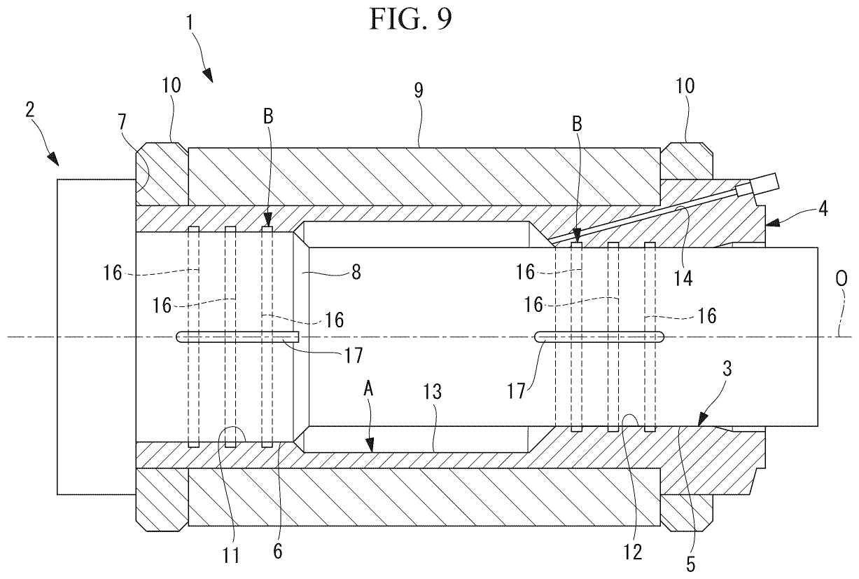

Furthermore, as shown in FIG. 9, a plurality of annular circumferential grooves 16 may be provided in the inner surfaces of the small-diameter hole portion 12 and the large-diameter hole portion 11, and linear connecting grooves 17 may be provided in the outer surface of the main shaft 2. Conversely, a plurality of annular circumferential grooves 16 may be provided in the outer surfaces of the small-diameter shaft portion 5 and the large-diameter shaft portion 6, and linear connecting grooves 17 may be provided in the inner surfaces of the small-diameter hole portion 12 and the large-diameter hole portion 11.

Furthermore, at least one of: the spiral grooves 15; the circumferential grooves 16 and the connecting grooves 17; or the linear grooves 18 may be provided in the small-diameter hole portion 12, the small-diameter shaft portion 5, the large-diameter hole portion 11, and the large-diameter shaft portion 6.

In this embodiment, the oil-pressure supply hole 14 is formed in the intermediate hole portion 13. Instead of this, the oil-pressure supply hole 14 may be formed in any one of the spiral grooves 15, the circumferential grooves 16, the connecting grooves 17, and the linear grooves 18 provided in the small-diameter hole portion 12 and the large-diameter hole portion 11.

Although the embodiments of the present disclosure have been described in detail, the present disclosure is not limited to the above-described embodiments. Various additions, replacements, changes, partial deletion, and the like can be made to these embodiments without departing from the gist of the disclosure or without departing from the idea and the gist of the present disclosure derived from the contents described in the claims and equivalents thereof. For example, in the above-described embodiments, the order of operations and the order of processes are shown as examples and are not exhaustive. The same applies to the case where numerical values or mathematical expressions are used in the description of the above-described embodiments.

1. A rotor sleeve comprising:
a through-hole into which a shaft including a small-diameter shaft portion and a large-diameter shaft portion having different outer diameters and disposed side by side in a direction of an axis is fitted, wherein
the through-hole includes: a small-diameter hole portion and a large-diameter hole portion that are disposed away from each other in the direction of the axis and into which the small-diameter shaft portion and the large-diameter shaft portion are tightly fitted, respectively; and an intermediate hole portion disposed between the small-diameter hole portion and the large-diameter hole portion,
each of the small-diameter hole portion and the large-diameter hole portion includes, in an inner surface thereof, a groove extending from an intermediate position thereof in the direction of the axis to the intermediate hole portion, and
the rotor sleeve comprises an oil-pressure supply hole that is formed in an inner surface of the intermediate hole portion or an inner surface of the groove.

2. The rotor sleeve according to claim 1, wherein the intermediate hole portion has a larger length in the direction of the axis than the small-diameter hole portion and the large-diameter hole portion, and a larger inner diameter than the small-diameter hole portion.

3. The rotor sleeve according to claim 1, wherein the groove is distributed in a circumferential direction of the inner surface of each of the small-diameter hole portion and the large-diameter hole portion.

4. The rotor sleeve according to claim 1, wherein the groove is a spiral groove.

5. The rotor sleeve according to claim 1, wherein the groove includes one or more circumferential grooves formed annularly over an entire circumference, and a connecting groove connecting the circumferential grooves and the intermediate hole portion.

6. The rotor sleeve according to claim 1, wherein the groove includes a plurality of grooves provided at intervals in a circumferential direction.

7. A rotor comprising:
a shaft in which a small-diameter shaft portion and a large-diameter shaft portion having different outer diameters are disposed side by side in a direction of an axis; and
a rotor sleeve including a through-hole into which the shaft is fitted, wherein
the through-hole includes: a small-diameter hole portion and a large-diameter hole portion that are disposed away from each other in the direction of the axis and into which the small-diameter shaft portion and the large-diameter shaft portion are tightly fitted, respectively;
and an intermediate hole portion disposed between the small-diameter hole portion and the large-diameter hole portion,
at least one of inner surfaces of the small-diameter hole portion and the large-diameter hole portion, and outer surfaces of the small-diameter shaft portion at a position to be fitted to the small-diameter hole portion and the large-diameter shaft portion at a position to be fitted to the large-diameter hole portion each include a groove extending from an intermediate position of each of the small-diameter hole portion and the large-diameter hole portion in the direction of the axis to the intermediate hole portion, and
the rotor comprises an oil-pressure supply hole that is formed in an inner surface of the intermediate hole portion, the groove, or an outer surface of the shaft that faces the intermediate hole portion in a radial direction.

8. The rotor according to claim 7, wherein the intermediate hole portion has a larger length in the direction of the axis than the small-diameter hole portion and a larger inner diameter than the small-diameter hole portion.

9. The rotor according to claim 7, wherein the groove is distributed in a circumferential direction of the inner surface of each of the small-diameter hole portion and the large-diameter hole portion.

10. The rotor according to claim 7, wherein the groove is a spiral groove.

11. The rotor according to claim 7, wherein the groove includes one or more circumferential grooves formed annularly over an entire circumference, and a connecting groove connecting the circumferential grooves and the intermediate hole portion.

12. The rotor according to claim 7, wherein the groove includes a plurality of grooves provided at intervals in a circumferential direction.
